(19) United States
(12) Patent Application Publication
(10) Pub. No.: US 2010/0101058 A1
(43) Pub. Date: Apr. 29, 2010

(54) BRASSIERE BACK CLOSURE

(76) Inventors: Gerhard Fildan, Vienna (AT); Karl Wanzenbock, Teesdorf (AT)

Correspondence Address: K.F. ROSS P.C., 5683 RIVERDALE AVENUE, SUITE 203 BOX 900, BRONX, NY, 10471-0900, US

(21) Appl. No.: 12/256,503

(22) Filed: Oct. 23, 2008

(51) Int. Cl. A41F 1/00; B23P 17/00

(52) U.S. Cl. 24/578.14; 29/592

(57) ABSTRACT

A brassiere back closure has an inelastic textile patch is attached to the end of one of the brassier wings and carries a plurality of transversely extending and longitudinally spaced rows each having at least two transversely spaced eyes on the back face. A flat body has an inner end attached to the end of the other of the wings, an opposite outer end, a front face at least partially overlapping at the outer end the back face of the patch, and a back face opposite the body front face. Respective plastic hooks generally complementary to and matable with the eyes are fixed to the body front face at the outer end so as to align with and interfit with the eyes. A transversely rigid bar on or forming part of the body prevents transverse relative movement of the hooks and bending of the body at the hooks.

### FIELD OF THE INVENTION

The present invention relates to a brassiere. More particularly this invention concerns a back closure or fastener for a brassiere.

### BACKGROUND OF THE INVENTION

A standard brassiere comprises a pair of rearwardly open cups adapted to fit over the wearer's breasts and having inner edges that are connected together and outer edges from which extend wing straps that pass under the wearer's arms and around to the wearer's back where they overlay and are releasably joined together at a closure. A strap normally extends from the top of each cup over the respective shoulder of the wearer and is connected at the wearer's back to a top edge of the respective wing.

The standard closure is formed as a plurality of horizontally spaced vertical rows of eyes provided on an outer or back face of an end of one of the wings and a complementary vertical row of hooks on a front or inner face of the end of the other of the wings. The hooks are engaged in the eyes of one of the rows to fasten the two wing ends together. For comfort, the wings are typically made of an elastic textile, but the ends carrying the hooks and eyes are somewhat stiffer.

While the standard hook/eye closure is effective, it has several problems. The metallic hooks are themselves hard and can dig into the back of the wearer and get caught on other garments when the brassiere is laundered. The closure is also bulky so that it can be seen underneath tight clothing, creating an unattractive bump in the middle of the wearer's back. Finally, when longitudinal stress is applied pulling the two wing ends apart, the entire closure can curl, projecting out at its upper and lower edges and also at the outer edge of the back. Such curling deformation increases with tension and makes the already existing unattractive bump in the middle of the wearer's back even bigger.

Manufacture of the closure from various elements involves several assembly and fastening steps that increase the cost of the closure. They are typically stitched together and it is very difficult to provide stitching that perfectly matches the textile elements of the fastener, normally contrasting somewhat when the garment is new and always contrasting after some use.

### OBJECTS OF THE INVENTION

It is therefore an object of the present invention to provide an improved brassiere back closure.

Another object is the provision of such an improved brassiere back closure that overcomes the above-given disadvantages, in particular that is extremely flat so that it can be worn under tight clothing without being visible, and that does not curl outward when the wings are tensioned.

A further object is to provide an improved and simplified method of making such a closure, one that in particular avoids the use of unattractive stitching.

### SUMMARY OF THE INVENTION

A closure for connection between ends of two back wings of a brassiere has according to the invention an inelastic textile patch having a back face turned away from a wearer of the brassiere and an opposite front face. The patch is attached to the end of one of the wings and carries a plurality of transversely extending and longitudinally spaced rows each having at least two transversely spaced first closure elements made of plastic on the back face. A flat body has an inner end attached to the end of the other of the wings, an opposite outer end, a front face at least partially overlapping at the outer end the back face of the patch, and a back face opposite the body front face. Respective plastic second closure elements generally complementary to and matable with the first closure elements are fixed to the body front face at the outer end so as to align with and interfit with the first closure elements. A transversely rigid bar on or forming part of the body prevents transverse relative movement of the second closure elements and bending of the body at the second closure elements.

Such a closure can be made extremely thin measured front to back, in fact as thin as 4 mm, which is considerably thinner than the 6 mm of a standard closure. What is more, the construction is such that tension exerted on it by the wings does not cause it to curl or twist back, but in fact simply makes it flatter, so that it never presents an unattractive bump, even if worn, for instance, under a snug tee shirt. This closure can be wholly made without stitching, that is by welding, normally ultrasonically, so that there is never the problem of unattractive contrasting stitching.

The first closure elements are female and U-shaped and the second closure elements are male. They are both wholly made of plastic so as not to snag, for instance, in the laundry. What is more, such completely nonmetallic construction is quite simple and cheap, and avoids some of the skin-sensitivity and allergy problems of metallic parts.

The patch according to the invention is formed by congruous front and back textile layers and the first closure elements each include a front part sandwiched between the layers, a back part matable with a respective one of the second closure elements, and a peg or web extending through the back layer between the respective front and back parts. The pegs or webs can be formed integrally with the respective front and back parts or they can be formed integrally with one of the respective front and back parts and ultrasonically welded to the other of the respective front and back parts.

Each of the layers is generally rectangular and the closure further has ultrasonic welds extending around at least three sides of the layers and bonding same together immediately inward of outer edges thereof. These welds, according to a particularly advantageous form of the invention, only extend around the three sides and the layers are separate at a fourth side. The respective wing end is received between and fastened to the layers at the fourth side. Of course one or both of the layers can also in fact be formed as an integral part of the brassiere wing if the fastener is to be manufactured with the undergarment.

In accordance with the invention transverse bar welds are formed between the rows of first closure elements. These prevent the closure from curling and maintain an accurate spacing between the first closure elements.

The flat body according to the invention can also unitarily formed of plastic with the second closure elements and rigid bar. In this case at least one flexible textile flap is secured to the rigid bar and attached to the respective wing end, or more particularly two such textile flaps sandwich and are welded to the bar and also sandwich and are attached to the respective wing end.

The method according to the invention comprises the steps of fixing a plurality of first closure elements made of plastic to a front face of an inelastic textile patch having a back face turned away from a wearer of the brassiere and an opposite front face with the first closure elements are arrayed in a plurality of transversely extending and longitudinally spaced rows on the back face and also providing a flat body having an inner end attached to the end of the other of the wings and an opposite outer end and a front face at least partially overlapping the back face of the patch at the outer end and a back face opposite the body front face. Respective plastic second closure elements generally complementary to the first closure elements are fixed to the body front face at the outer end so as to align with and interfit with the first closure elements. A transversely rigid bar is formed on or as part of the body so as to prevent transverse relative movement of the second closure elements and bending of the body at the second closure elements.

As described above, the patch is formed by congruous front and back textile layers and the first closure elements each include a front part sandwiched between the layers, a back part matable with a respective one of the second closure elements, and a peg or web extending through the back layer between the respective front and back parts. These front and back parts can be unitarily formed with each other, with the pegs or web, and with the bar in a single shot by injection molding, or alternately the pegs or webs are formed integrally with one of the respective front and back parts and are welded to the other of the respective front and back parts.

### BRIEF DESCRIPTION OF THE DRAWING

The above and other objects, features, and advantages will become more readily apparent from the following description, reference being made to the accompanying drawing in which:

FIG. 1A is a front view of the closure according to the invention;

FIG. 1B is a section taken along line IB-IB of FIG. 1A;

FIGS. 1C and 1D are front views of the female and male parts of the closure;

FIGS. 1E and 1F are back views of the female and male parts of the closure;

FIGS. 2A and 2B are front and back views of the outer female element;

FIG. 2C is a cross section through the outer female element;

FIGS. 2D and 2E are front and back views of the inner female element;

FIG. 2F is a cross section through the inner female element;

FIGS. 2G and 2H are front and back views through the plastic part of the male part of the closure;

FIG. 2I is a section taken along line 2I-2I of FIG. 2G;

FIG. 2J is a front view of the fabric for the male part of the closure;

FIGS. 3A and 3B are views of the base and patch fabric blanks for the layers of the female part;

FIGS. 3C and 3D are front and back views after installation of the inner and outer female elements on the base blank;

FIGS. 3E is a front view of the blanks after heat-sealing them together;

FIG. 3F is a front view showing trimming of the sealed-together blanks;

FIG. 4A is a front view of a second closure according to the invention;

FIG. 4B is a section taken along line IVB-IVB of FIG. 4A;

FIGS. 4C and 4D are front views of the female and male parts of the second closure;

FIGS. 4E and 4F are back views of the female and male parts of the second closure;

FIGS. 5A and 5B are views of the base and patch fabric blanks for the layers for the female part of the second closure;

FIGS. 5C and 5D are front and back views after installation of the plastic parts on the base blank;

FIG. 5E is a front view of the blanks after heat-sealing them together;

FIGS. 5F is a front view showing trimming of the sealed-together blanks;

FIGS. 6A and 6B are views of the base and patch fabric blanks for the layers for the male part of the second closure;

FIGS. 6C and 6D are front and back views after installation of the plastic parts on the base blank;

FIG. 6E is a front view of the blanks after heat-sealing them together; and

FIGS. 6F is a front view showing trimming of the sealed-together blanks.

### SPECIFIC DESCRIPTION

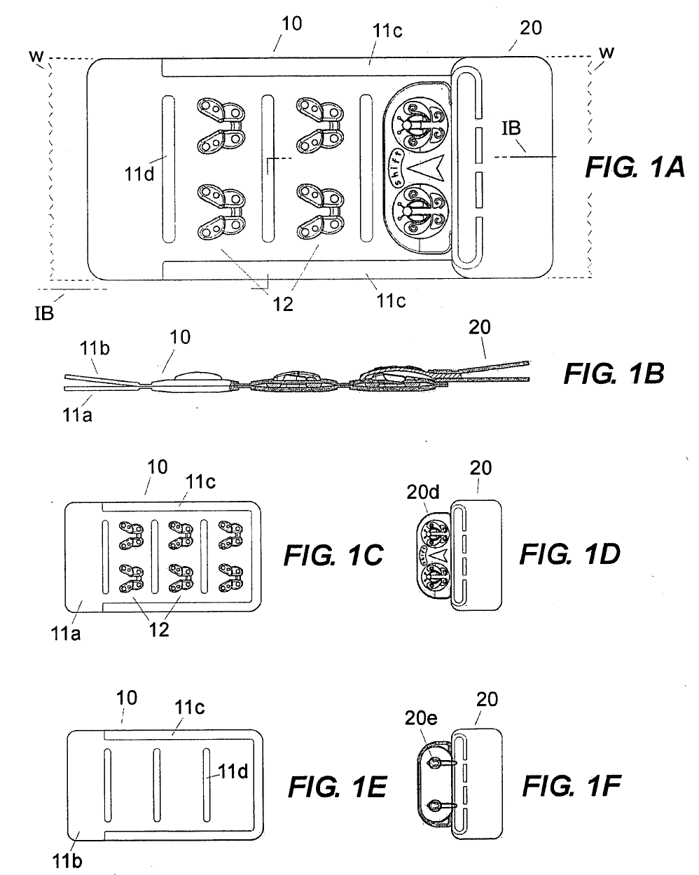

As seen in FIGS. 1A-1F a closure according to the invention basically comprises a female part 10 normally attached to one wing shown in dashed lines at W and a male part 20 attached to another wing W. FIG. 1A shows the closure as seen from the rear, that is from behind the person wearing it, when attached together in its longest setting.

The female part 10 is formed by front and back layers 11a and 11b of which at least one, here both, is made of a nonstretch textile, typically a tricot knit microfiber. These layers 11a and 11b are bonded together along their longitudinal edges and outer end at a U-shaped weld 11c. In addition crosswise welds 11d are longitudinally spaced along the ultrasonically welded-together layers 11a and 11b within the area defined by the weld 11c to further stabilize the assembly by eliminating stretch. The U-shaped edge weld 11c ends short of the inner ends of the layers 11a and 11b and the innermost crosswise weld 11d also is spaced outward from this inner end so that the two layers 11a and 11b are separate at the inner end of the female part 11, forming fastening lips. This allows the two layers 11a and 11b to be sandwiched to opposite inner and outer faces of the respective wing W and fastened thereto by welding or stitching in a manner providing a solid anchoring and smooth joint.

Three rows of two female butterfly elements 12 are secured to the back face of the back layer 11b in longitudinally spaced transversely extending rows. In principal each row could have more than two such elements 12 for brassieres with larger cup sizes, but in practice as described below it is often only necessary to increase the transverse spacing of the two elements 12, not the number, with an increase in the transverse dimension of the fastener to match wider wings W.

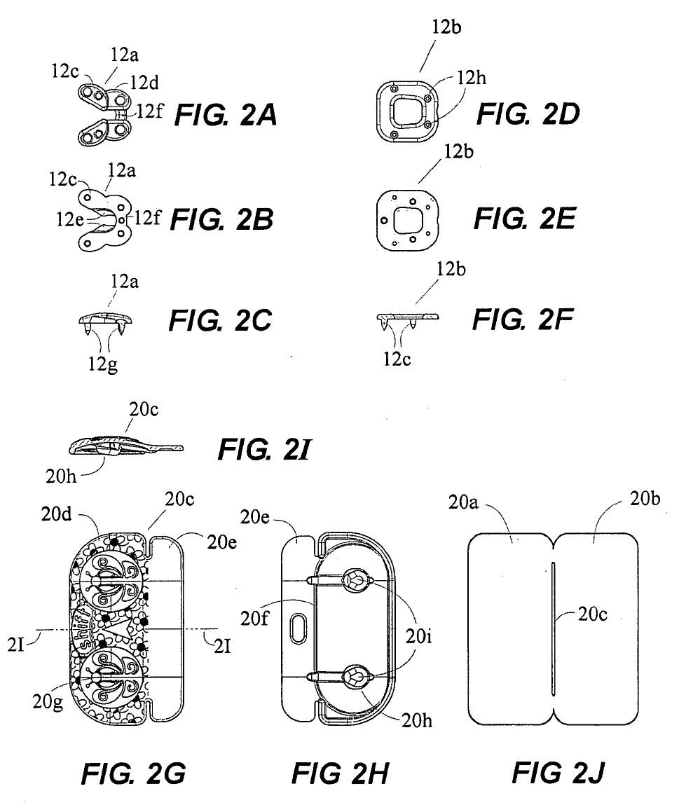

Each female element 12 comprises as better shown in FIGS. 2A-2C a butterfly-shaped back part 12a that sits on the back face of the back layer 11b and a rectangularly annular inner part 12b (FIGS. 2D-2F) that is sandwiched between the front face of the back layer 11b and the back face of the front layer 11a. The front part 12a is butterfly shaped with a pair of wings having diverging outer portions 12c, parallel inner portions 12d formed with overhangs 12e, and a bight 12f joining the bottom ends of the inner portions 12d. Prongs 12g extend from the front face of the female element 12 through the back layer 11b and seat in holes 12h in the front part 12b that in turn has prongs 12i functioning similarly.

The male part 20 as better shown in FIGS. 2G-2J comprises a flexible but normally inelastic textile part formed by front and back layers 20a and 20b formed in turn by halves of a common textile rectangle (FIG. 2J) with a central slot 20c, and a plastic part 20c with an outer part 20d and an inner bar part 20e joined by a somewhat narrower web 20f adapted to fit through the slot 20c as will be described below. The outer part 20c has a back face provided with decoration and indicia 20g including the word “SHIFT” and an arrow pointing outward to indicate to the user which way to slide this part 20 to open the closure.

It would also be possible to make a system where the flaps 20a and 20b were not a single piece, and one of the pieces is made large to cover the entire back or outer face of the plastic part 20d so that nothing but textile is seen from the rear.

The front face of the outer part 20c is formed with a pair of hook elements 20h each having an enlarged head 20i and an inwardly extending ridge 20j. The heads 20i can fit underneath the overhangs 12e to lock the parts 10 and 20 together against separation in any direction but toward each other, that is by moving the part 20 in the direction of the “SHIFT” arrow of the indicia 20g. The ridges 20j that are inward of the heads 20i serve to guide the heads 20i into position by sliding between the arms 12c of the parts 12a.

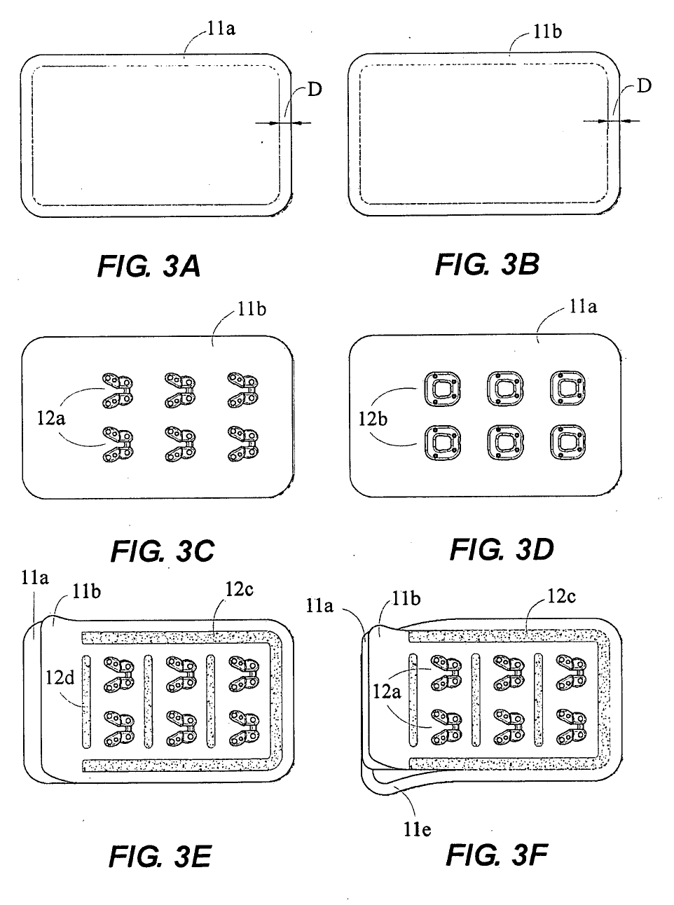

The female part 10 of this closure is made as shown in FIGS. 3A-3F by first laminating together two blanks 11a′ and 11b″ (FIGS. 3A and 3B) that are of the same shape as the layers 11a and 11b, but larger all around by a dimension D here equal to about 0.125 in.

In a first step shown in FIG. 3C and 3D the parts 12a and 12b are fitted together in the three rows of two each (to which the invention is in no way limited) with the prongs 12g and 12i poking through the blank 11b′ and ensuring exact relative positioning of these parts 12a and 12b. The fitted together parts 12a and 12b are, in this position, welded together ultrasonically at the outer ends of the prongs where they project through to mushroom them over and lock the parts 12a and 12b solidly together with the blank 11b′ between them.

Then as shown in FIG. 3E the two blanks 11a′ and 11b′ are fitted congruently together, and the welds 12c and 12d are formed, which can be done ultrasonically. This stiffens the assembly somewhat and completely encloses the parts 12b.

In a final step an edge 11e is trimmed off the blanks 11a′ and 11b′ to turn them into the layers 11a and 11b. This trimming is done cold, immediately adjacent or slightly outside the ultrasonic weld 12c so that, as the fabric of the layers 11a and 11b frays slightly with use and laundering a soft edge is left.

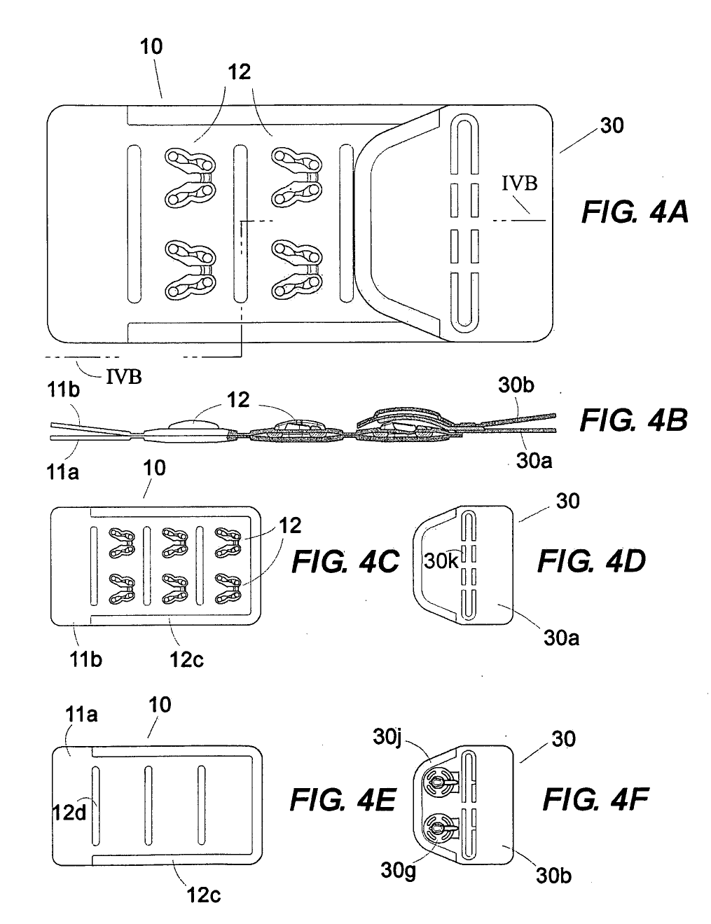

The embodiment of FIGS. 4A-6F functions similarly and has all the advantages of the first embodiment described above but differs with respect to how it is assembled, and the construction of the male part 30.

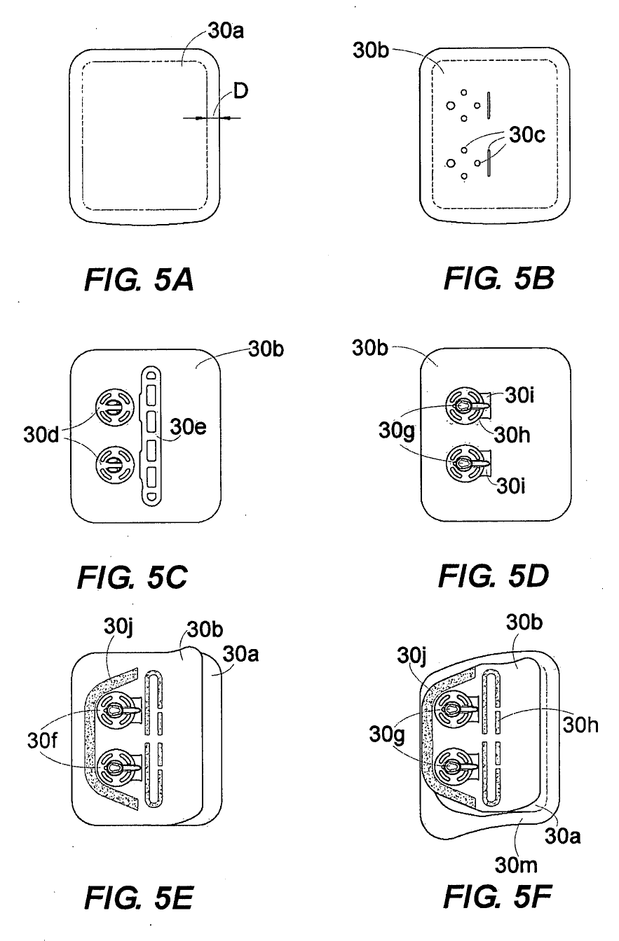

More particularly, the male part 30 here is not formed of two pieces, namely the textile element shown in FIG. 2J and the plastic part shown in FIGS. 2G and 2H. Instead it is formed as shown in FIGS. 5A and 5B starting from two blanks 30a′ and 30b′, the former a simple unperforated patch and the latter formed with an number of throughgoing holes 30c, both oversize by the dimension D.

The blank 30b′ is then as shown in FIGS. 5C and 5D fitted between two mold or die halves and a synthetic resin is injected into it to form on the front face of the blank 30b′ two small circular back buttons 30d and a crosswise bar 30e and on its back face two flat buttons 30f from which project heads 30g identical to the heads 20i and ridges 30g identical to the ridge 20j. An integral flat web 30i is simultaneously formed that extends through the blank 30b′ between the buttons 30d and 30f, which are also connected together through integral studs extending through the holes 30c between the buttons 30d and 30f. Thus all the plastic parts are formed in a single shot and are unitary with each other.

Then as shown in FIG. 5E, the two blanks 30a′ and 30b′ are congruently juxtaposed so that the front blank 30a′ covers the buttons 30d and the reinforcing bar 30e, and the two blanks 30a′ and 30b′ are ultrasonically welded together at a U-shaped weld 30j extending around the buttons 30d and 30fd and a straight ultrasonic weld 30k at the bar 30e to bond the two blanks solidly together and to the plastic parts 30d, 30f, 30e, and 30i.

Finally a cold cut is formed around the weld 30j, that is spaced slightly outward from it, to cut off an edge 30m to form front and back layers 30a and 30b with a soft edge and a pair of lips between which the respective wing W can be anchored.

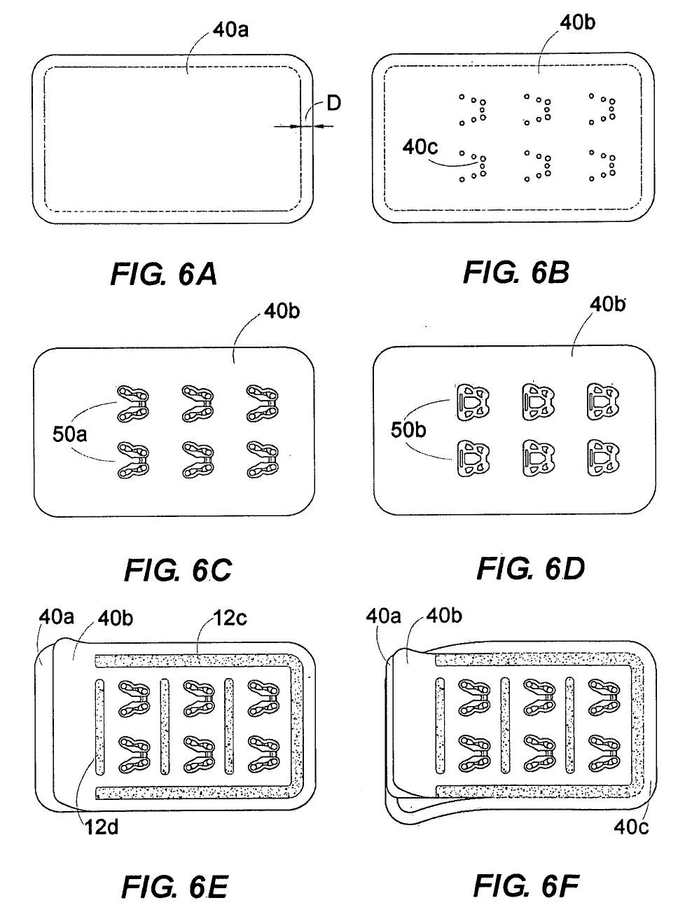

The female part of the second embodiment is formed as shown in FIGS. 6A-6F with integrally injection molded plastic parts also.

More particularly as shown in FIGS. 6A and 6B, the process starts with two blanks 40a′ and 40b′, the former identical to the blank 11a′ and the latter only different from the blank 11b′ in that it is formed with six U-shaped arrays of throughgoing holes.

The blank 40b′ is then, like the blank 30b′, clamped between two die halves into which plastic is injected to form parts 50a and 50b essentially identical to the parts 12a and 12b, except that they are unitarily formed with each other and connected together by tiny integral pegs extending though the holes 40c. This is shown in FIGS. 6C and 6D.

The steps shown at 6E and 6F are identical to those of FIGS. 3E and 3F, with welds 12c and 12d formed, then an edge 40c trimmed off to leave a front layer 40a and back layer 40b with a soft edge and two flaps that can be joined to a wing end.

We claim:

1. A closure for connection between ends of two back wings of a brassiere, the closure comprising:
an inelastic textile patch having a back face turned away from a wearer of the brassiere and an opposite front face, the patch being attached to the end of one of the wings;
a plurality of transversely extending and longitudinally spaced rows each having at least two transversely spaced first closure elements made of plastic fixed to the back face;
a flat body having an inner end attached to the end of the other of the wings, an opposite outer end, a front face at least partially overlapping at the outer end the back face of the patch, and a back face opposite the body front face;
respective plastic second closure elements generally complementary to and matable with the first closure elements and fixed to the body front face at the outer end so as to align with and interfit with the first closure elements; and
a transversely rigid bar on or forming part of the body and preventing transverse relative movement of the second closure elements and bending of the body at the second closure elements.

2. The closure defined in claim 1 wherein the first closure elements are female and U-shaped and the second closure elements are male.

3. The closure defined in claim 1 wherein the patch is formed by congruous front and back textile layers and the first closure elements each include a front part sandwiched between the layers, a back part matable with a respective one of the second closure elements, and a peg or web extending through the back layer between the respective front and back parts.

4. The closure defined in claim 3 wherein the pegs or webs are formed integrally with the respective front and back parts.

5. The closure defined in claim 3 wherein the pegs or webs are formed integrally with one of the respective front and back parts and are welded to the other of the respective front and back parts.

6. The closure defined in claim 3 wherein each of the layers is generally rectangular, the closure further comprising:
welds extending around at least three sides of the layers and bonding same together immediately inward of outer edges thereof.

7. The closure defined in claim 6 wherein the welds only extend around the three sides and the layers are separate at a fourth side, the respective wing end being received between and fastened to the layers at the fourth side.

8. The closure defined in claim 6, further comprising:
transverse bar welds between the rows of first closure elements.

9. The closure defined in claim 1 wherein the flat body is unitarily formed of plastic with the second closure elements and rigid bar.

10. The closure defined in claim 9, further comprising at least one flexible textile flap secured to the rigid bar and attached to the respective wing end.

11. The closure defined in claim 10 wherein there are two such textile flaps sandwiching and ultrasonically welded to the bar and also sandwiching and attached to the respective wing end.

12. A method of making a closure for connection between ends of two back wings of a brassiere, the method comprising the steps of:
fixing a plurality of first closure elements made of plastic to a front face of an inelastic textile patch having a back face turned away from a wearer of the brassiere and an opposite front face with the first closure elements being arrayed in a plurality of transversely extending and longitudinally spaced rows on the back face;
providing a flat body having an inner end attached to the end of the other of the wings, an opposite outer end, a front face at least partially overlapping the back face of the patch at the outer end, and a back face opposite the body front face;
fixing respective plastic second closure elements generally complementary to the first closure elements to the body front face at the outer end so as to align with and interfit with the first closure elements; and
forming a transversely rigid bar on or as part of the body so as to prevent transverse relative movement of the second closure elements and bending of the body at the second closure elements.

13. The method defined in claim 12 wherein the patch is formed by congruous front and back textile layers and the first closure elements each include a front part sandwiched between the layers, a back part matable with a respective one of the second closure elements, and a peg or web extending through the back layer between the respective front and back parts.

14. The method defined in claim 13 wherein the front and back parts are unitarily formed with each other, with the pegs or web, and with the bar in a single shot by injection molding.

15. The method defined in claim 13 wherein the pegs or webs are formed integrally with one of the respective front and back parts and are welded to the other of the respective front and back parts.

16. The method defined in claim 13 wherein each of the layers is generally rectangular, the method further comprising the step of:
forming welds extending around at least three sides of the layers and bonding same together immediately inward of outer edges thereof.

17. The method defined in claim 16 wherein the welds only extend around the three sides and the layers are separate at a fourth side, the method further comprising the step of
securing the respective wing end between the layers at the fourth side.

18. The method defined in claim 16, further comprising the step of:
forming transverse bar welds between the rows of first closure elements.

19. The method defined in claim 13 wherein the flat body is unitarily formed of plastic with the second closure elements and rigid bar.

20. The method defined in claim 19, further comprising the steps of:
providing at least one flexible textile flap secured to the rigid bar, and
attaching the flaps to the respective wing end.
